(19) United States
(12) Patent Application Publication
(10) Pub. No.: US 2025/0003820 A1
(43) Pub. Date: Jan. 2, 2025

(54) MAGNETIC DRIVE-OVER SYSTEM PROVIDING TIRE PRESSURE MEASUREMENT

(71) Applicant: Bridgestone Americas, Inc., Nashville, TN (US)

(72) Inventors: Steven NOYCE, Mebane, NC (US); Michael STANGLER, Raleigh, NC (US)

(21) Appl. No.: 18/706,148

(22) PCT Filed: Nov. 1, 2022
(86) PCT No.: PCT/US2022/048532

§ 371 Date: Apr. 30, 2024

Related U.S. Application Data
(60) Provisional application No. 63/274,121, filed on Nov. 1, 2021.

(51) Int. Cl. G01L 17/00

(52) U.S. Cl. CPC G01L 17/005

(57) ABSTRACT

A system for measuring an internal pressure of a tire can include processing circuitry and memory coupled to the processing circuitry. The memory can have instructions stored therein that are executable by the processing circuitry to cause the processing circuitry to perform operations. The operations can include determining an area of a contact patch of the tire on a drive over surface. The operations can further include determining a load on the tire. The operations can further include determining the internal pressure of the tire based on the load on the tire and the area of the contact patch.

### CROSS REFERENCE TO RELATED APPLICATIONS

This application is a 35 U.S.C. §371 national stage application of PCT International Application No. PCT/US2022/048532 filed on Nov. 1, 2022, which in turn claims the benefit of priority from U.S. Provisional Application No. 63/274,121 filed Nov. 1, 2021, the disclosure and content of which are incorporated by reference herein in their entirety.

### TECHNICAL FIELD

The present disclosure relates generally to determining tire pressure, and more particularly a magnetic drive-over system (“DOS”) providing tire pressure measurement.

### BACKGROUND

The pressure of the gas a tire has been inflated with can be referred to as tire pressure. In some examples, tire pressure may be measured manually using a tire pressure gauge. In additional or alternative examples, a vehicle may include an on-board tire-pressure monitoring system (“TPMS”) to measure tire pressure. Some TPMS indirectly measure tire pressure. For example, an anti-lock brake sensor can indirectly detect that one tire has lower tire pressure than the other tires by detecting that one tire is rotating faster than the other tires. Other TPMS directly measure tire pressure, for example, by communicating with a tire pressure sensor within the tire. Such sensors may be used to automatically monitor tire pressure, and a warning (e.g., a warning light) may be provided to the driver when low pressure is detected.

Improper tire pressure can accelerate tire tread wear, which can lead to more frequent tire replacement and/or reduced safety. In some examples, tires that are driven while under-inflated can generate heat that weakens the tire to the point of failure. In additional or alternative examples, tires that are rapidly deflating can cause a driver to lose control of a vehicle.

### SUMMARY

According to some embodiments, a system for measuring an internal pressure of a tire is provided. The system includes processing circuitry and memory coupled to the processing circuitry. The memory has instructions stored therein that are executable by the processing circuitry to cause the processing circuitry to perform operations. The operations include determining an area of a contact patch of the tire on a drive over surface. The operations further include determining a load on the tire. The operations further include determining the internal pressure of the tire based on the load on the tire and the area of the contact patch.

According to other embodiments, a system for measuring an internal pressure of a tire is provided. The system includes a drive over surface, a contact sensor, a load sensor, and processing circuitry. The drive over surface is configured to receive the tire thereon. The contact sensor is configured to measure information associated with a contact patch of the tire on the drive over surface. The load sensor is configured to measure a load on the tire as the tire moves over the drive over surface. The processing circuitry is communicatively coupled to the contact sensor and the load sensor and configured to determine the internal pressure of the tire based on the information associated with the contact patch and the load on the tire.

According to other embodiments, a method for measuring an internal pressure of a tire is provided. The method includes determining an area of a contact patch of the tire on a drive over surface. The method further includes determining a load on the tire. The method further includes determining the internal pressure of the tire based on the load on the tire and the area of the contact patch.

According to other embodiments, a non-transitory computer-readable medium is provided. The non-transitory computer-readable medium has instructions stored therein that are executable by processing circuitry to cause the processing circuitry to perform operations. The operations include determining an area of a contact patch of the tire on a drive over surface. The operations further include determining a load on the tire. The operations further include determining the internal pressure of the tire based on the load on the tire and the area of the contact patch.

According to other embodiments, a distributed system for determining an internal pressure of a tire is provided. The distributed system includes a plurality of distributed processing circuitry and one or more memory devices each coupled to at least one distributed processing circuitry of the plurality of distributed processing circuitry. The one or more memory devices have instructions stored therein that are executable by the plurality of distributed processing circuitry to cause the plurality of distributed processing circuitry to perform operations. The operations include determining an area of a contact patch of the tire on a drive over surface. The operations further include determining a load on the tire. The operations further include determining the internal pressure of the tire based on the load on the tire and the area of the contact patch.

According to some embodiments of inventive concepts, a system can be provided to improve the monitoring of vehicle tires and improve car safety.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a perspective view illustrating an example of a drive over system for providing tire pressure measurement according to some embodiments of inventive concepts;

FIG. 2 is a cross sectional view illustrating an example of a housing of the drive over system of FIG. 1 according to some embodiments of inventive concepts;

FIG. 3 is a zoomed-in cross sectional view illustrating an example of the housing of the drive over system of FIG. 1 according to some embodiments of inventive concepts;

FIG. 4 is a cross sectional view illustrating an example of a single sensor system with magnets mounted vertically and with a sensor positioned along an axis between magnets according to some embodiments of inventive concepts;

FIG. 5 is a cross sectional view illustrating an example of a multi-sensor array system with magnets mounted vertically with each sensor positioned along a respective axis between two magnets according to some embodiments of inventive concepts;

FIGS. 6A-C are top and side views illustrating an example of a housing with two cavities for respective distinct sensor arrays according to some embodiments of inventive concepts;

FIGS. 7-8 are heat maps illustrating examples of data indicating an area of a contact patch of a tire according to some embodiments of inventive concepts;

FIG. 9 is a diagram illustrating an example of a system including two linear arrays of sensors (one array with magnets and one array without magnets) according to some embodiments of inventive concepts;

FIG. 10 is a block diagram illustrating an example of a controller configured to determine tire pressure according to some embodiments of inventive concepts; and

FIG. 11 is a flow chart illustrating an example of operations performed by a drive over system for determining tire pressure according to some embodiments of inventive concepts.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Various embodiments described herein provide a procedure for measuring tire pressure based on a load on the tire and an area of a contact patch of the tire on a surface. In some examples, a contact patch refers to a portion of a tire that is in actual contact with a surface (e.g., a road surface). Conceptually, the internal tire pressure (P) of a tire can be estimated based on the load (L) on the tire and the area (A) of a contact patch associated with the tire using the equation P=L/A. In practice, this relationship is adjusted based on calibration factors that can be measured empirically to account for other variables (e.g., a material stiffness of the tire).

In some embodiments, a drive over system (“DOS”) is used to measure the load on the tire and the area of the contact patch. The DOS can include processing circuitry that determines a tire pressure based on the measured load and area.

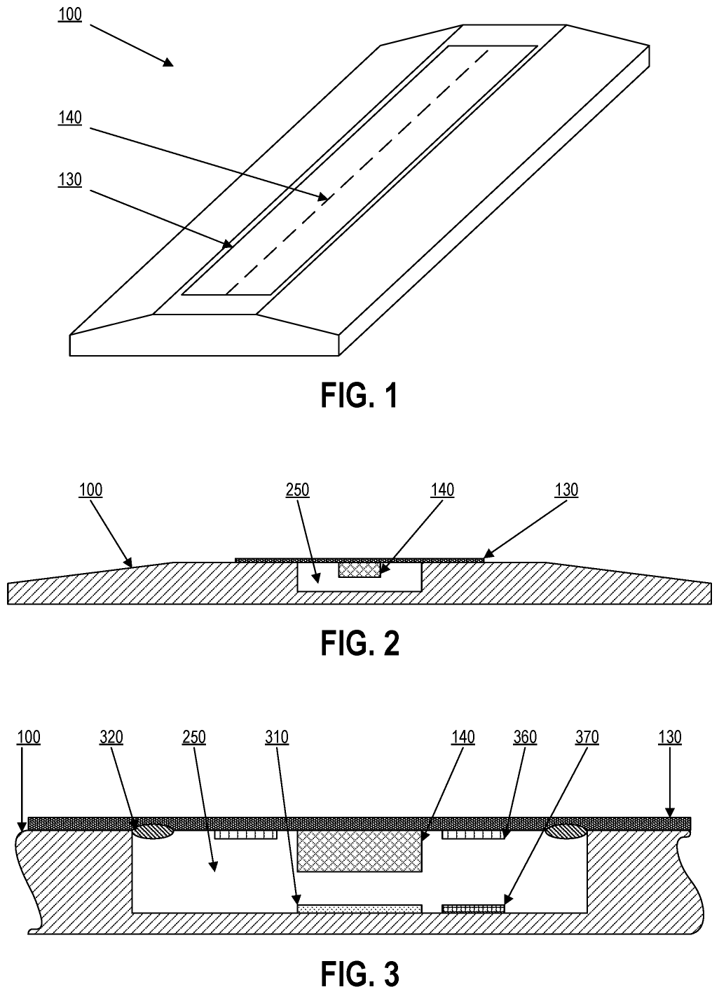

FIGS. 1-3 illustrate an example of a DOS 100 that can determine a tire pressure of a tire that drives across it. The DOS 100 can have a housing with a shape similar to a speed bump (though any suitable shape can be used) with a first slope that rises to a flat area and a second slope that extends back down from the flat area. A metal plate 130 may be positioned over the flat area to provide a drive over surface.

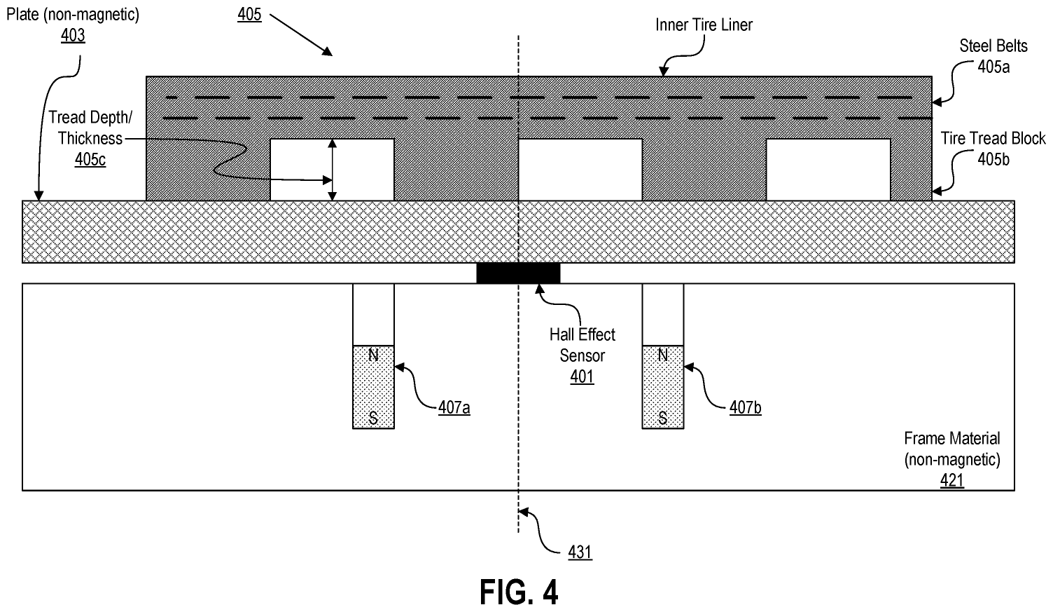

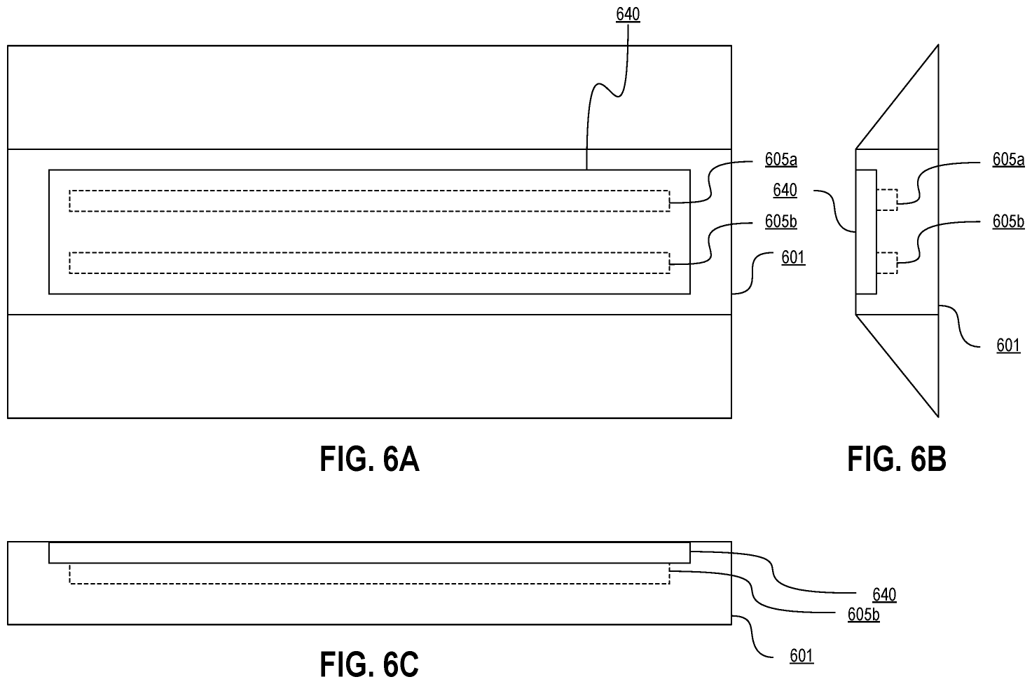

In this example, the housing includes a cavity 250. A linear sensor array is positioned within the cavity 250 and extends the length of the metal plate 130. The linear sensor array can include magnets and/or magnetic sensors (as illustrated in FIGS. 4 and 6) that can measure a change in a magnetic field caused by a tire driving over the DOS 100. In some examples, the change in the magnetic field can be used to determine the area of the contact patch.

In this example, a pressure sensor 310 is positioned with the cavity 250. The pressure sensor 310 can output an indication of the load on a tire as the tire moves across the DOS 100. In some examples, the pressure sensor 310 generates a response (e.g., an electrical signal) that is proportional to the load in response to a change in pressure in the cavity 250 caused by deflection of the metal plate 130 (which can include a semi-rigid layer). In this example, the cavity 250 is sealed to allow the pressure sensor to operate effectively. However, in other implementations, the cavity 250 may not be sealed.

In this example, load cells 320 are positioned within the cavity 250 and are configured to measure a load on a tire as the tire moves across the DOS 100.

In this example, strain gauges 360 are positioned within the cavity 250 and coupled to the metal plate 130. The strain gauges 360 can be configured to measure a deflection of the metal plate 130, which can be used to determine a load on the tire.

In additional or alternative examples, capacitors (e.g., compressible parallel-plate capacitors or flex capacitors) can be included between the metal plate 130 and a rigid portion of the housing and measure a load on the tire based on a deflection of the metal plate 130. In additional or alternative embodiments, only a subset of the pressure sensor 310, load cells 320, strain gauges 360, capacitors, or another suitable load sensor is included in a DOS. In additional or alternative embodiments, the housing may include multiple cavities that each include one or more load sensors and/or contact patch sensors. In other embodiments, a DOS does not include a load sensor and instead receives an indication of a load on a tire from a vehicle associated with the tire or a remote device (e.g., a separate scale).

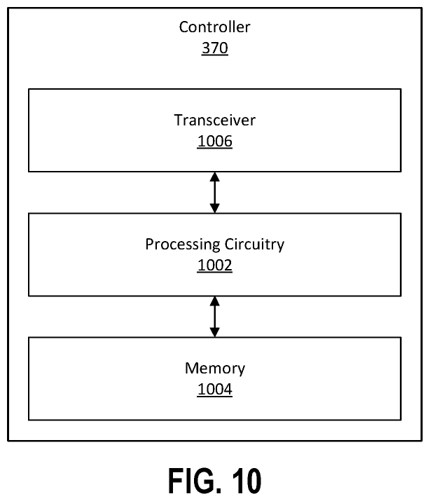

FIG. 3 further illustrates an example of the DOS 100 including a controller 370 positioned in the cavity 250. The controller 370 (further illustrated in FIG. 10) can include processing circuitry 1002 communicatively coupled to memory 1004 and a transceiver 1006. The memory 1004 can include instructions that are executable by the processing circuitry 1002 to cause the DOS 100 to perform operations. In some embodiments, the operations include determining an internal pressure of a tire based on a load on the tire and a contact patch of the tire on a drive over surface. In additional or alternative embodiments, the transceiver 1006 can receive indications of the load and/or area. In additional or alternative embodiments, the transceiver 1006 can transmit an indication of the tire pressure.

In some embodiments, one or more sensors in a DOS can measure data associated with a tire and transmit the data to a remote device (e.g., a cloud-based device) for subsequent analysis and reporting to an operator of a vehicle associated with the tire.

Various embodiments are described below for determining a contact patch of a tire as it drives over a DOS.

Some embodiments of inventive concepts described herein may provide a magnetic sensor system used to determine a contact patch of a tire on a drive over surface. In some examples, the magnetic sensor system is able to determine the thickness of rubber on a tire outside of the steel belts. This thickness may include both the tread rubber and the thin layer(s) of rubber between the bottom of the grooves and the steel belts, and this thickness may be used to determine a tread depth (also referred to as a tread thickness). In some embodiments, magnetic sensors of the magnetic sensor system can be mounted on PCBs to allow for sensor array scaling and dimensional control.

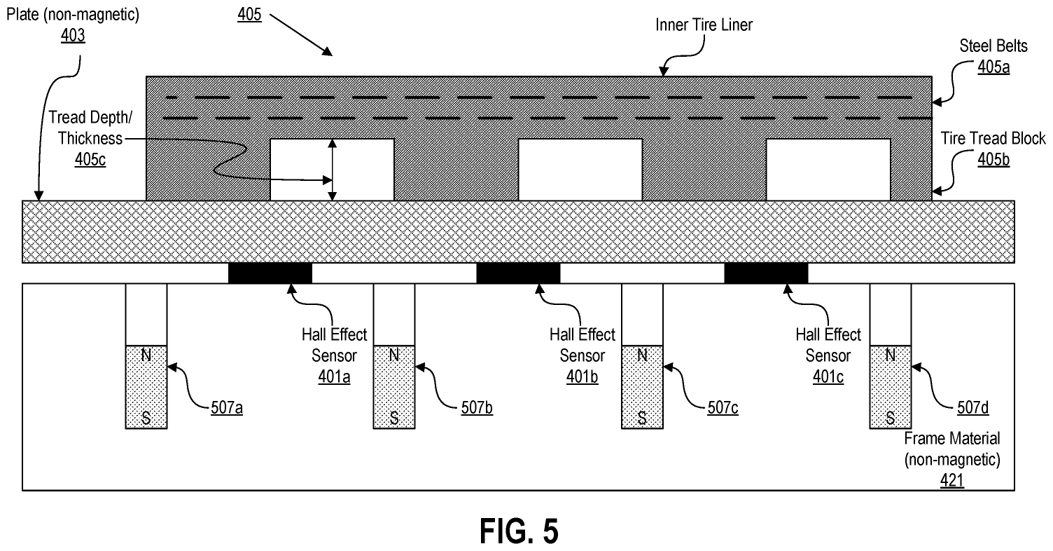

The system may be enclosed in a housing (e.g., a housing 501 as discussed in greater detail below with respect to FIG. 5) that protects the electronics, sensors and magnets, and the housing may provide a structure for vehicles to drive over, allowing the sensors to measure the response of the tires to the induced magnetic fields generated by the magnets in the housing.

Some embodiments of inventive concepts may provide a magnetic sensor that, when coupled with magnets (e.g., permanent magnets or electromagnets) aligned in a plane orthogonal to the plane in which the sensor resides, provides for measurement of the magnetic field associated with the steel belts in response to the magnets when the tire is directly adjacent to the array. Similarly, an array of sensors with a concomitant array of magnets can be employed to measure fields along the length of an array as shown in FIG. 6. A plate of non-magnetic material (e.g. aluminum, Delrin, etc.), also referred to as a non-magnetic layer or non-magnetic plate, can be placed over the top of the array of sensors and magnets to protect them from the tire rolling over the array as shown in FIGS. 1-3. Poles of the magnets (e.g., permanent magnets and/or electromagnets) are each oriented vertically, either all north poles N face up and all south poles face down (as shown in FIGS. 4 and 6), or all south poles S face up and all north poles N face down.

The magnets can be arranged in a multitude of ways around the sensors including trigonal, square, pentagonal, or hexagonal, or other arrangements. In addition, the magnets can be positioned such that a magnet is directly below (in the same vertical axis as) the sensor.

FIG. 4 illustrates a single sensor system with magnets 407a and 407b (e.g., permanent magnets or electromagnets) mounted vertically and with the same polarity facing up. As shown in FIG. 4, all north poles N may face up toward the non-magnetic plate 403, but according to other embodiments, all south poles S may face up toward the non-magnetic plate 403. The tire 405 with steel belts 405a is positioned above the sensor 401 as the tire 405 rolls over the sensor with tread blocks 405b on the sensor 401. The non-magnetic plate 403 protects/separates the sensor 401 (and magnets 407a and 407b with frame 421) from the tire 405. While the cross sectional view of FIG. 4 shows two magnets 407a and 407b on opposite sides of a vertical axis 431 through the sensor 401, any number of magnets may be arranged around the vertical axis 431 through the sensor 401.

As shown in FIG. 4, the magnets 407a and 407b may be recessed in the nonmagnetic frame 421. While not shown, the Hall effect sensor 401 may also be recessed in the nonmagnetic frame 421. Moreover, top surfaces of the magnets 407a and 407b may be below the Hall effect sensor 401 as shown to increase sensitivity of the system. When the tire 405 is on the nonmagnetic plate 403 opposite the magnets 407a and 407b and the Hall effect sensor 401, the steel belts 405a of the tire interact with the magnetic field produced by the magnets 407a and 407b, and these interactions with the magnetic field detected by the Hall effect sensor 401 can be used to determine tread depth/thickness 405c and/or a contact patch of the tire on the non-magnetic plate 403.

FIG. 5 illustrates a multi-sensor array system with magnets 507a, 507b, 507c, and 507d (e.g., permanent magnets and/or electromagnets) mounted in the nonmagnetic frame 521 so that the nonmagnetic plate 403 is between the magnets 507a, 507b, 507c, and 507d and the tire 405. In FIG. 5, a plurality of Hall effect sensors 401a, 401b, and 401c are provided (on or recessed in the non-magnetic frame 521) to allow separate measurements of the tire tread depth/thickness 405c across a width of the tire 405. In FIG. 5, each Hall effect sensor may operate as discussed above with respect to the single Hall effect sensor of FIG. 4. While the cross-sectional view of FIG. 5 shows all of the magnets and sensors in a same vertical plane, the magnets may be arranged in any suitable manner. As discussed above with respect to FIG. 4, top surfaces of the magnets may be below the Hall effect sensors to increase sensitivity of the system.

FIGS. 6A-C illustrates housing 601 with two cavities 605a and 605b for respective distinct sensor arrays. The two cavities 605a-b can be configured to each include an array of magnetic sensors.

Non-magnetic cover plate 640 (also referred to as a top plate, plate, non-magnetic layer, etc. as discussed above) may cover the cavities 605a-b to protect magnetic sensors therein and to define the distance from each sensor of the array to the tire. In the top view of FIG. 6A, cavities 605a-b are marked with dashed lines to indicated that cavities 605a-b are below non-magnetic cover plate 640. By providing a recess for non-magnetic cover plate 640, a top surface of non-magnetic cover plate 640 may be flush with an adjacent surface of housing 601.

Sensors and/or sensor array structures (e.g., as discussed above with respect to one or more of FIGS. 1-5) may be provided in cavities 605a-b, and non-magnetic cover plate 640 may be provided over the sensor/array. According to some embodiments discussed above with respect to the cross-sectional views of FIG. 4, the sensor structure may be defined to include frame 421, hall effect sensor 401, and magnets 407a and 407b, and this structure may be provided in each of cavity 605a and 605b of housing 601, and non-magnet cover plate 640 (corresponding to plate 403 of FIG. 4) may be provided over the sensor structure. According to some embodiments discussed above with respect to the cross-sectional view of FIG. 5, the sensor array structure may be defined to include frame 521, hall effect sensors 401a, 401b, and 401c, and magnets 507a, 507b, 507c, and 507d, and this structure may be provided in cavities 605a-b of housing 601, and non-magnet cover plate 640 (corresponding to plate 403 of FIG. 5) may be provided over the sensor structure in cavities 605a-b.

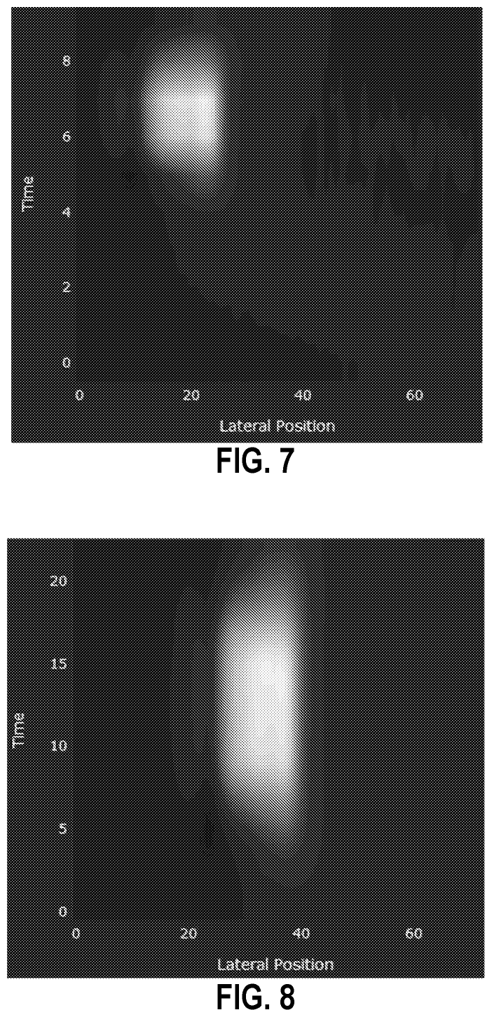

In some embodiments, a DOS uses a linear array of sensors to measure tire tread depth in a continuous stream, which can include data as a function of time. This data as a function of time can be represented as a heat map (e.g., as illustrated in FIGS. 7-8). For a given tire and pressure condition, a fast moving vehicle will generate a short sensor track while a slow moving vehicle will generate a longer track. As such, the length of the sensor data track can be a function of both the actual tire patch length and the speed of the vehicle. To determine the tire patch length from the sensor data track, it may be necessary to know the speed of the tire over the sensor array.

In FIGS. 7-8 illustrate examples of heat maps generated from data measured by sensor arrays in response to two different vehicles driving over a DOS at two different speeds. In this example, the vehicle associated with FIG. 7 was driven roughly 6 times faster than the vehicle associated with FIG. 8.

Various embodiments are described below for determining a velocity of a tire (or vehicle associated with the tire) as it drives over a DOS.

In some embodiments, multiple linear sensor arrays inside the DOS can be used to determine a speed of the vehicle. In some examples, a first sensor can detect a tire at a first position at a first time and a second sensor can detect the tire at a second position at a second time. The speed of the tire can be calculated based on the difference in the first time and the second time and the difference in the first position and the second position. In additional or alternative examples, the first sensor and the second sensor can be a combination of load sensors (e.g., strain gauges) and/or contact patch sensors (e.g., the magnetic sensors).

In additional or alternative embodiments, a separate sensor (e.g., pneumatic tubes, cameras, or RFID readers) can be used to measure a speed of the vehicle.

In additional or alternative embodiments, a speed of the vehicle associated with the tire can be received from the vehicle or a remote device.

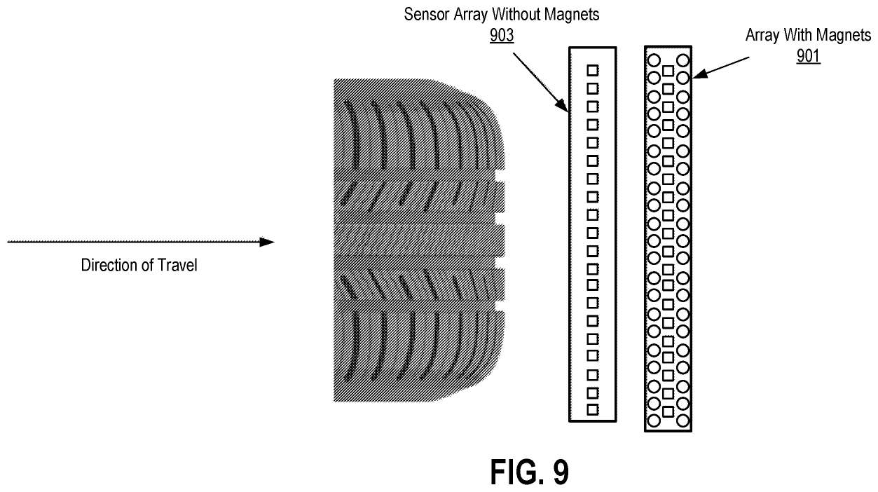

Multi-array systems are discussed below with respect to FIG. 9. As shown in FIG. 9, two linear arrays of Hall effect sensors may be provided, one array 903 without magnets and one array 901 with magnets. In arrays 901 and 903, the squares indicate magnetic sensors, and in array 901, the circles indicate magnets.

According to some embodiments of inventive concepts, the system may deploy two sensor arrays perpendicular to the direction of tire travel—one array 901 with magnets and the second array 903 without magnets as shown in FIG. 9. The sensor array 901 with magnets (indicated by circles) provides an overall response to both the residual magnetization in the steel belts of the tire (e.g., including residual magnetic fields, shape anisotropy, etc. in the steel belts of the tire) and the fields from the magnets. The sensor array 903 without the magnets picks up only the former (e.g., residual magnetic fields, shape anisotropy, etc. in the steel belts of the tires). The residual fields can then be mathematically extracted from the response measured using the sensors array with magnets. This approach may provide a method of fine-tuning the magnetic response and accounting for stray, residual fields. Stated in other words, the sensors of array 901 measure the disruption of the magnetic fields from the magnets of array 901 because of the steel belts of the tire being present. The closer the steel belts are, the more significant their impact on the magnetic field lines from the magnets and thus the change in signal measured by the sensors.

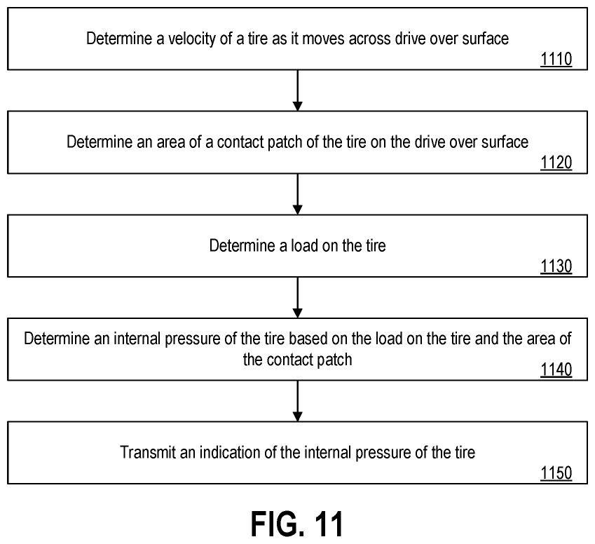

Operations of a DOS (e.g., the DOS 100 (implemented using the structure of the block diagram of FIG. 3)) will now be discussed with reference to the flow chart of FIG. 11 according to some embodiments of inventive concepts. In some examples, modules may be stored in memory 1004 of FIG. 10, and these modules may provide instructions so that when the instructions of a module are executed by respective DOS processing circuitry 1002, processing circuitry 1002 performs respective operations of the flow chart.

FIG. 11 illustrates example operations performed by a DOS to determine an internal pressure of a tire. In some embodiments, the DOS includes a drive over surface, a contact sensor, a load sensor, and processing circuitry. In additional or alternative embodiments, the DOS (e.g., DOS 100) includes a housing providing a drive over surface (e.g., metal plate 130) configured to receive the tire thereon and a cavity (e.g., cavity 250) therein. The cavity can include at least one of: processing circuitry (e.g., processing circuitry 1102); memory (e.g., memory 1104); a transceiver (e.g., transceiver 1106); a contact sensor (e.g., magnetic sensor array 140) configured to measure information associated with the contact patch of the tire on the drive over surface; and a load sensor (e.g., pressure sensor 310, load cell 320, or strain gauge 360) configured to measure the load on the tire as the tire moves over the drive over surface.

At block 1110, processing circuitry 1102 determines a velocity of a tire as it moves across a drive over surface. In some embodiments, determining the velocity includes determining a time between detection of the tire at a first position by a first sensor and detection of the tire at a second position by a second sensor; and determining the velocity based on the time and a distance between the first position and the second position.

At block 1120, processing circuitry 1102 determines an area of a contact patch of the tire on the drive over surface. In some embodiments, determining the area of the contact patch includes determining an indication of the area via a magnetic sensor positioned within a cavity of a housing that provides the drive over surface. In some examples, determining the indication of the area via the magnetic sensor includes determining an area of the tire that contacts the drive over surface based on a change in a magnetic field produced by a magnet in the housing and the tire as it moves across the drive over surface.

In additional or alternative embodiments, determining the area of the contact patch includes determining a length of the contact patch based on the velocity and the change in the magnetic field; determining a width of the contact patch based on the change in the magnetic field; and determining the area of the contact patch based on the length and the width.

At block 1130, processing circuitry 1102 determines a load on the tire. In some embodiments, determining the load includes determining an indication of the load via at least one of: a pressure sensor positioned within a sealed cavity of a housing that provides the drive over surface; a load cell positioned beneath a semi-rigid layer of the drive over surface; a capacitor positioned between the semi-rigid layer of the drive over surface and a rigid layer of the drive over surface; and a strain gauge coupled to the semi-rigid layer of the drive over surface.

In additional or alternative embodiments, determining the load includes receiving an indication of the load. In some examples, the indication is received from an external system (e.g., a vehicle associated with the tire and/or a remote device).

At block 1140, processing circuitry 1102 determines an internal pressure of the tire based on the load on the tire and the area of the contact patch. In some embodiments, determining the internal pressure based on the load and the area includes dividing the load by the area.

At block 1150, processing circuitry 1102 transmits, via transceiver 1106, an indication of the internal pressure of the tire. In some embodiments, the indication of the internal pressure is transmitted to a vehicle associated with the tire. In additional or alternative embodiments, the indication of the internal pressure is transmitted to a remote device. In some examples, the remote device is a display for illustrating the internal pressure of the tire. In additional or alternative examples, the remote device is a central device for monitoring the internal pressure for multiple tires of the same vehicle and/or other vehicles.

Although FIG. 11 is described above as being performed by a DOS, the operations can be performed by any suitable system including a distributed system (e.g., a cloud network). In some examples, a distributed system receives an indication of the area of the contact patch and an indication of the load on the tire and determines the internal pressure of the tire based on the area of the contact patch and the load on the tire.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

The dimensions of elements in the drawings may be exaggerated for the sake of clarity. Further, it will be understood that when an element is referred to as being “on” another element, the element may be directly on the other element, or there may be an intervening element therebetween. Moreover, terms such as “top,” “bottom,” “upper,” “lower,” “above,” “below,” and the like are used herein to describe the relative positions of elements or features as shown in the figures. For example, when an upper part of a drawing is referred to as a “top” and a lower part of a drawing is referred to as a “bottom” for the sake of convenience, in practice, the “top” may also be called a “bottom” and the “bottom” may also be a “top” without departing from the teachings of the inventive concept (e.g., if the structure is rotate 180 degrees relative to the orientation of the figure).

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor (also referred to as a controller) such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following claims and their equivalents, and shall not be restricted or limited by the foregoing detailed description.

1. A system for measuring an internal pressure of a tire, the system comprising:
processing circuitry; and
memory coupled to the processing circuitry and having instructions stored therein that are executable by the processing circuitry to cause the processing circuitry to perform operations comprising:
determining an area of a contact patch of the tire on a drive over surface;
determining a load on the tire; and
determining the internal pressure of the tire based on the load on the tire and the area of the contact patch.

2. The system of claim 1, further comprising:
a housing providing a drive over surface configured to receive the tire thereon and the housing including a cavity therein, the cavity including at least one of:
the processing circuitry;
the memory;
a transceiver;
a contact sensor configured to measure information associated with the contact patch of the tire on the drive over surface; and
a load sensor configured to measure the load on the tire as the tire moves over the drive over surface.

3. The system of claim 2, further comprising:
a nonmagnetic layer providing the drive over surface,
wherein the contact sensor comprises:
a magnet having opposing first and second magnetic poles, the nonmagnetic layer being between the drive over surface and the magnet, and the magnet being arranged so that the first magnetic pole is between the second magnetic pole and the nonmagnetic layer;
a magnetic sensor associated with the magnet that is configured to detect a magnetic field resulting from the magnet and the tire on the drive over surface, and
wherein determining the area of the contact patch of the tire comprises determining the area of the contact patch based on a plurality of measurements of the magnetic field obtained while the tire moves over the drive over surface.

4. (canceled)

5. The system of claim 2, the operations further comprising
determining a velocity of the tire at a time in which the tire was in contact with the drive over surface,
wherein determining the area of the contact patch of the tire is based on the velocity.

6. The system of claim 5, further comprising:
a first sensor configured to detect the tire at a first position;
a second sensor configured to detect the tire at a second position,
wherein determining the velocity comprises:
determining a time between detection of the tire by the first sensor and detection of the tire by the second sensor; and
determining the velocity based on the time and a distance between the first position and the second position.

7. The system of claim 6, wherein the first sensor and the second sensor are configured so that the tire rolls over one before the other.

8. The system of claim 6, wherein the first sensor and the second sensor each comprise one of:
a magnetic sensor;
a load sensor; or
a camera.

9. The system of claim 2, wherein the drive over surface comprises a semi-rigid layer,
wherein the cavity is a sealed cavity, and
wherein the load sensor comprises a pressure sensor configured to generate a calibrated response proportional to the load on the tire in response to deflection of the semi-rigid layer as the tire moves over the drive over surface.

10. The system of claim 2, wherein the drive over surface comprises a semi-rigid layer, and
wherein the load sensor comprises a load cell configured to generate a calibrated response proportional to the load on the tire as the tire moves over the drive over surface.

11. The system of claim 2, wherein the drive over surface comprises a semi-rigid layer and a rigid layer, and
wherein the load sensor comprises a compressible parallel-plate capacitor positioned between the semi-rigid layer and the rigid layer and configured to generate a calibrated response proportional to the load on the tire as the tire moves over the drive over surface.

12. The system of claim 2, wherein the drive over surface comprises a semi-rigid layer, and
wherein the load sensor comprises a strain gauge coupled to the semi-rigid layer and configured to generate a calibrated response proportional to the load on the tire as the tire moves over the drive over surface.

13. The system of claim 1, wherein determining the load on the tire comprises receiving an indication of the load on the tire from at least one of:
a vehicle associated with the tire; and
a remote device.

14. The system of claim 1, further comprising:
a transceiver communicatively coupled to the processing circuitry,
the operations further comprising:
transmitting, via the transceiver, an indication of the internal pressure to at least one of:
a vehicle associated with the tire; and
a remote device.

15. A system for measuring an internal pressure of a tire, the system comprising:
a drive over surface configured to receive the tire thereon;
a contact sensor configured to measure information associated with a contact patch of the tire on the drive over surface;
a load sensor configured to measure a load on the tire as the tire moves over the drive over surface; and
processing circuitry communicatively coupled to the contact sensor and the load sensor and configured to determine the internal pressure of the tire based on the information associated with the contact patch and the load on the tire.

16. (canceled)

17. A method for measuring an internal pressure of a tire, the method comprising:
determining an area of a contact patch of the tire on a drive over surface;
determining a load on the tire; and
determining the internal pressure of the tire based on the load on the tire and the area of the contact patch.

18. The method of claim 17, wherein determining the area of the contact patch comprises determining an indication of the area via a magnetic sensor positioned within a cavity of a housing that provides the drive over surface.

19. The method of claim 18, wherein determining the indication of the area via the magnetic sensor comprises:
determining an area of the tire that contacts the drive over surface based on a change in a magnetic field produced by a magnet in the housing and the tire as it moves across the drive over surface.

20. The method of claim 19, wherein determining the area of the contact patch comprises:
determining a velocity of the tire at a time in which the tire is in contact with the drive over surface, wherein determining the velocity comprises:
determining a time between detection of the tire at a first position by a first sensor and detection of the tire at a second position by a second sensor; and
determining the velocity based on the time and a distance between the first position and the second position;
determining a length of the contact patch based on the velocity and the change in the magnetic field; and
determining a width of the contact patch based on the change in the magnetic field; and
determining the area of the contact patch based on the length and the width.

21. (canceled)

22. The method of claim 17, wherein determining the load comprises determining an indication of the load via at least one of:
a pressure sensor positioned within a sealed cavity of a housing that provides the drive over surface;
a load cell positioned beneath a semi-rigid layer of the drive over surface;
a capacitor positioned between the semi-rigid layer of the drive over surface and a rigid layer of the drive over surface; and
a strain gauge coupled to the semi-rigid layer of the drive over surface.

23. (canceled)

24. The method of claim 17, wherein determining the internal pressure based on the load and the area comprises dividing the load by the area.

25.-30. (canceled)
